(19) United States
(12) Patent Application Publication
(10) Pub. No.: US 2019/0263034 A1
(43) Pub. Date: Aug. 29, 2019

(54) SYSTEM AND METHOD FOR PRODUCING A FOAMED POLYMER

(71) Applicant: Covestro Deutschland AG, Leverkusen (DE)

(72) Inventors: Paul Heinz, Leverkusen (DE); Andreas Frahm, Köln (DE); Stephan Moers, Brüggen (DE); Christian Hahn, Leverkusen (DE)

(21) Appl. No.: 16/320,034

(22) PCT Filed: Jul. 26, 2017
(86) PCT No.: PCT/EP2017/068929

§ 371 Date: Jan. 23, 2019

(30) Foreign Application Priority Data
Jul. 29, 2016 (EP) 16181863.8

(51) Int. Cl. B29C 44/58; B29C 44/60; B29C 44/34

(52) U.S. Cl. CPC B29C 44/586; B29K 2075/00; B29C 44/3442; B29C 44/60

(57) ABSTRACT

Provided herein is a system for producing a foamed polymer. The system comprises a first mixer for mixing at least two mutually reactive reaction components to obtain a reaction mixture that reacts to afford a polymer. At least one of the reaction components further comprises a supercritical fluid. The system further comprises a foaming mold for receiving the reaction mixture which is connected to the first mixer and has a first volume available for receiving the reaction mixture. The first volume is variable. Also provided herein is a process for producing a foamed polymer.

The present invention relates to a system for producing a foamed polymer, comprising a first mixer for mixing at least two mutually reactive reaction components to obtain a reaction mixture that reacts to afford a polymer, wherein at least one of the reaction components further comprises a supercritical fluid; and to a foaming mold for receiving the reaction mixture which is connected to the first mixer and has a first volume available for receiving the reaction mixture, wherein the first volume is variable. The invention further relates to a process for producing a foamed polymer using such a system.

Nanocellular or nanoporous polymer foams are particularly good thermal insulation materials on the basis of theoretical considerations. This is because the internal dimensions of the foam structures are of the order of the mean free path length of a gas molecule. The gas contribution to heat transfer can be reduced in this way. Polyurethanes are a group of polymers which are frequently used in thermal insulation.

Polyurethane foams are produced by reacting a polyol component, which also contains a blowing agent, with an isocyanate. The reaction of isocyanate with water forms carbon dioxide, which also acts as a blowing agent.

The decisive step for foam formation, and hence for the later cell size of the cured foam, is the nucleation provided by blowing agents, since every cell in the foam has been formed from a gas bubble. A relevant observation here is that, after nucleation, no new gas bubbles are generally produced, but instead blowing agent diffuses into existing gas bubbles.

Addition of stabilizers promotes the emulsification of the various components, influences nucleation and prevents coalescence of growing gas bubbles. They also influence cell opening. In open-cell foams, the membranes of the growing pores are opened and the struts of the pores are left standing.

One possible approach is to emulsify a supercritical blowing agent into the reaction mixture and then to cure the foam after reducing the pressure. The POSME method (principle of supercritical micro emulsion expansion) is known as a variant thereof. The blowing agent is present therein in the form of a microemulsion. Microemulsions form under certain conditions which depend inter alia on the concentration of emulsifiers and on the temperature. Microemulsions are notable for their stability and for the fact that the nonpolar phase, i.e., the blowing agent in this case, can be present within the polar phase in very small droplets. The diameters of such droplets can range from 1 to 100 nanometers.

DE 102 60 815 A1 discloses foamed material and a process for producing the foamed material. Foamed material comprising foam bubbles in nanosize is supposed to be produced without having to surmount the energy barrier typical of phase conversions and nucleus-forming processes. An associated goal is to produce, in a controllable manner, a foamed material that has a numeric density of foam bubbles between 10¹² and 10¹⁸ per cm³ and also an average diameter for the foam bubbles of between 10 nm and 10 μm. The foundation is the dispersion of a second fluid in the form of pools in a matrix of a first fluid. A reaction space contains the first fluid as a matrix and the second fluid in pools. A change in pressure and/or temperature is used to convert the second fluid into a near-critical or supercritical state with a density close to that of a liquid. The second fluid is therefore fully or almost fully in the form of pools which have a uniform distribution in the entire first fluid. Depressurization causes the second fluid to revert to a state of gaseous density, while the pools inflate into foam bubbles of nanometer size. No energy barrier has to be surmounted, nor do the blowing agent molecules have to diffuse to the expanding bubbles.

Any polymerizable substance is said to be generally useful as first fluid. However, express mention is only made of acrylamide, which polymerizes to give polyacrylamide, and melamine, which polymerizes to give melamine resin. The second fluid should be selected from a group of materials which comprises hydrocarbons such as methane or ethane, alkanols, (hydro)chlorofluorocarbons or CO₂. A further material used is an amphiphilic material that should have at least one block with affinity for the first fluid and at least one block with affinity for the second fluid.

WO 2011/054873 A2 relates to a process for producing a polyurethane foam, wherein the employed blowing agent is in the supercritical or near-critical state. A reaction mixture is introduced into a closed mold and the closed mold is set up such that its internal volume and/or the pressure prevailing in its interior can be varied by external agency after the mixture has been introduced. Through choice of the surfactant, microemulsions of the blowing agent in the polyol phase may be obtained. This document further relates to a nanocellular polyurethane foam obtainable by the process.

WO 2012/059567 A1 discloses a process for producing a foamed material, wherein an emulsion-form composition comprising a matrix-forming component, a surfactant component and a near-critical or supercritical blowing agent component is subjected to a pressure reduction. The blowing agent component further comprises a hydrophobic co-component that is soluble in supercritical CO₂ at a pressure of ≥150 bar, is insoluble in subcritical CO₂ at a pressure of ≤40 bar and is insoluble in the matrix-forming component and is further present in a proportion of ≥3% by weight to ≤35% by weight of the blowing agent component. The publication further relates to an emulsion-form composition employable therein and to a foamed material obtainable by the process.

The mixing of a mixture of polyol and supercritical blowing agent (including catalyst and additives) with isocyanate in a high-pressure mixer is followed by commencement of the urethane reaction (viscosity increase) during which the pressure should not fall below the critical pressure of the employed gaseous blowing agent (preferably not below 100 bar in the case of CO₂) to avoid premature foaming This is ensured by injection of the reaction mixture into a reaction space exhibiting the required pressure and temperature conditions. These conditions in the reaction space are in practice brought about through the use of a so-called floating seal for separating the reaction space with respect to a pressure chamber (pressure increase for example by compressed air).

At the point in time when the reaction mixture exhibits the correct viscosity for foam formation the blowing agent may be transferred from the supercritical state into the gaseous state to induce foaming either by reducing the pressure (for example by opening a compressed air valve) or by enlarging the volume. The pressure conditions during the foaming procedure are decisive for various properties of the resulting foams (cell size, cell structure, porosity, apparent density, compressive strengths, dimensional stability, surface structure etc.)

On the basis of fundamental considerations the foaming process by volume enlargement of the reaction space is preferable over the process of pressure reduction in the reaction space since controlled volume enlargement can also control the pressure while the opposite is not unconditionally true.

Apparatuses for volume enlargement in the reaction space may operate with hydraulic pistons for example. However these have the disadvantage that the injection of the reaction mixture and the initial piston movement would need to proceed synchronously which is only ensurable by losing total control over the pressure conditions.

The present invention has for its object to provide an apparatus and a process for the production of a polymer foam where both the injection and the foaming procedure may be performed under controlled conditions.

The object is achieved in accordance with the invention by a system as claimed in claim 1 and a process as claimed in claim 8. Advantageous developments are specified in the subsidiary claims. They may be combined as desired, unless the opposite is apparent from the context.

The present invention is more particularly elucidated by the figures and examples which follow without, however, being limited thereto.

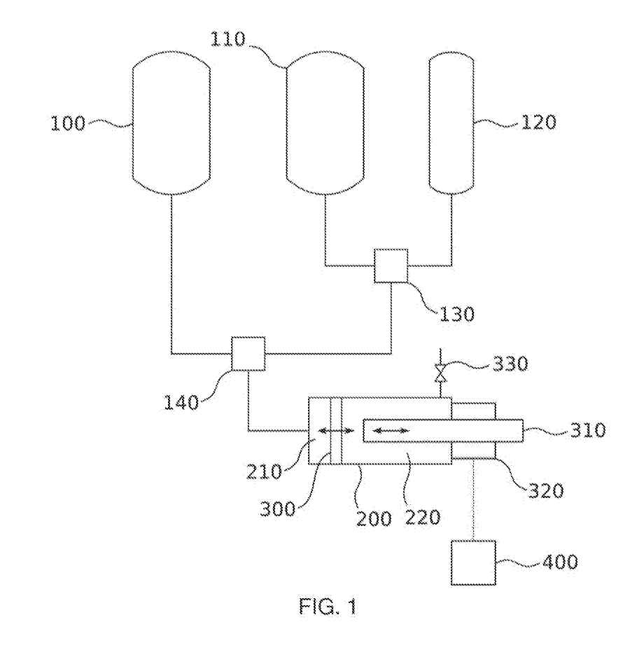

FIG. 1 shows an inventive system

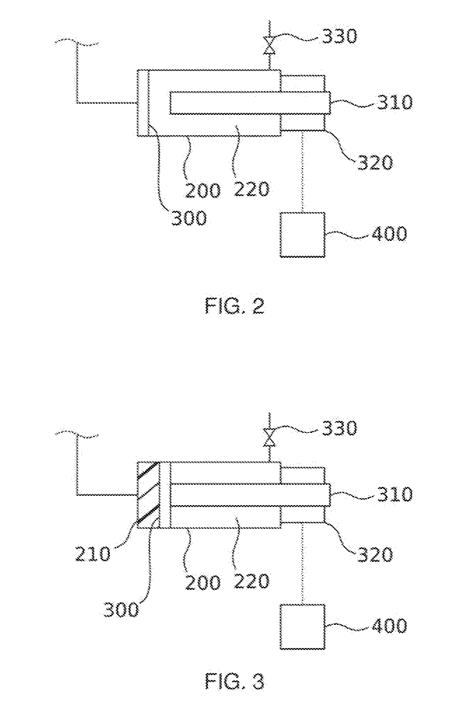

FIG. 2 shows a section of an inventive system for elucidating an inventive process

FIG. 3 shows a further section of an inventive system for elucidating an inventive process

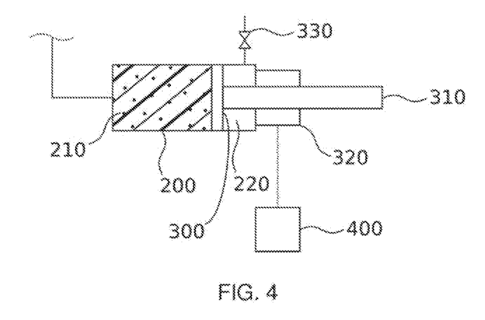

FIG. 4 shows a further section of an inventive system for elucidating an inventive process

A system according to the invention for producing a foamed polymer is shown in FIG. 1. The system comprises:
a first mixer 140 for mixing at least two mutually reactive reaction components to obtain a reaction mixture that reacts to afford a polymer, wherein at least one of the reaction components further comprises a supercritical fluid; and
a foaming mold 200 for receiving the reaction mixture which is connected to the first mixer 140 and has a first volume 210 available for receiving the reaction mixture, wherein the first volume 210 is variable.

The first mixer 140 is preferably a high-pressure mixer in order that supercritical conditions may be maintained during mixing for the fluid in the reaction mixture. Impingement jet mixers or micromixers for example are suitable. However it is also possible to configure the mixer in the form of a T-junction connected to appropriate conduits. Details concerning the reaction components of the reaction mixture are reported in connection with the process according to the invention.

Supercritical conditions may likewise be maintained in the foaming mold 200. The first mixer 140 is connected via a conduit to the foaming mold 200, so that a reaction mixture obtained in the first mixer 140 may be introduced into the foaming mold, more particularly into the variable first volume 210 of the foaming mold. With respect to its shape the foaming mold 200 is in principle not subject to any limitations. It will be appreciated that an internal shaping which facilitates the movement of the seal 300 is preferred.

In the system according to the invention the foaming mold 200 comprises a movable seal 300 which delimits the first volume 210 on at least one side and effects sealing at least against the outflow of liquid components. The mobility of the seal 300 is represented by the symbol ↔ in FIG. 1. The seal 300 thus contributes to the first volume 210 being variably configurable while maintaining supercritical conditions for the fluid. Said seal may also seal off the first volume against gases. However, in some cases the outflow of a certain gas quantity from the first volume 210 may be tolerated or even desired when this improves the foaming procedure of the reaction mixture in the operation of the system.

In simple cases the foaming mold 200 may have a circular internal cross section and the seal 300 is a cylindrical disk made of aluminum for example.

The system further comprises a movable limiter 310 which is arranged on the side of the seal 300 opposite the first volume 210, is not connected or not securely connected to the seal 300 and which has a position that is variable with a positioning unit 320, wherein the positioning unit 320 is adapted for performing instructions from a control unit 400. The mobility of the limiter 310 is likewise represented by the symbol ↔ in FIG. 1. The direction of mobility of the limiter 310 corresponds to the direction of mobility of the seal 300. The limiter 310 is not connected or not securely connected to the seal 300. In this way both elements may be arranged in the foaming mold 300 independently of one another. A non-secure connection may be realized by means of releasable elements such as electromagnets, releasable mechanical couplings and the like.

A positioning unit 320 effects the movement or blocking of the movement of the limiter 310 and thus comprises a propulsion for the limiter 310. The positioning unit 320 acts on the instructions of a control unit 400. The control unit 400 may be part of a process control system. The control unit preferably likewise receive signals from one or more position sensors in order to allow the position of the limiter 310 within the foaming mold to also feed into the instructions to the positioning unit 320.

The limiter 310 is positionable in such a way as to block or allow according to the instructions from the control unit 400 a movement of the seal 300 which corresponds to an enlargement of the first volume 210. A first volume 210 in which a chemical reaction takes place may thus be maintained or enlarged in controlled fashion.

It is preferable when the limiter 310 is implemented as a mechanically, hydraulically or pneumatically propelled piston.

The control unit 400 is adapted for relaying instructions to the positioning unit 320 according to at least one parameter of a reaction mixture located in the first volume 210. As the parameter, the pressure, the temperature and/or the viscosity in the volume 210 may be determined by means of a pressure sensor, temperature sensor/viscometer, for example Also capturable in volume 210 alternatively or else in addition, by IR spectroscopy, ultrasound techniques or other commonly used metrology techniques, are parameters characterizing the incipient foam that are passed on to the control unit 400 in order to relay instructions to the positioning unit 320. Thus the size of the first of volume 210 may be varied depending on the progress of the reaction within the reaction mixture.

According to the embodiment shown in FIG. 1 the system further comprises a reservoir vessel for a first reaction component 100, a reservoir vessel for a second reaction component 110 and a reservoir vessel for a fluid 120 transferable into a supercritical state, wherein the reservoir vessel for the second reaction component 110 and the reservoir vessel for the fluid 120 transferable into a supercritical state are connected to a second mixer 130 and an outlet of the second mixer 130 and also the reservoir vessel for the first reaction component 100 are connected to the first mixer.

It is preferable when the reservoir vessel for the first reaction component 100 is a reservoir vessel for an isocyanate component, the reservoir vessel for the second reaction component 110 is a reservoir vessel for a polyol component and the reservoir vessel for the fluid 120 transferable into a supercritical state is a reservoir vessel for carbon dioxide.

In a further embodiment of the system according to the invention the foaming mold 200 further comprises a second volume 220 arranged on the side of the seal 300 opposite to the first volume 210 which is sealable with respect to the atmosphere and whose pressure is adjustable by means of a valve 330. The second volume 220 may be used to build up counterpressure which ensures that during the expansion of the first volume the seal 300 moves relatively slowly, thus preventing inadvertent temporary subcritical conditions in the first volume. This counterpressure may be built up and released again via the valve 330.

Not shown in FIG. 1 but nevertheless possible is to also provide the foaming mold 200 with a valve for controlled air pressurization and depressurization of the first volume 210.

In a further embodiment of the system according to the invention the seal 300 is implemented as a floating seal. The floating seal is herein defined as a component which can effect pressure-tight sealing of the first volume 210 from the second volume 220 against the foaming mold 200 and which may be moved along an axis (in case of horizontal construction of foaming mold 200 then accordingly also horizontally) but is not mechanically connected to the foaming mold 200 or to the limiter 310.

In a further embodiment of the system according to the invention the limiter 310 is implemented as a mechanically, hydraulically or pneumatically propelled piston.

In a further embodiment of the system according to the invention the parameter of the reaction mixture located in the first volume 210 according to which the control unit 400 relays instructions to the positioning unit 320 is selected from: residence time of the reaction mixture in the first volume 210, temperature of the reaction mixture in the first volume 210, pressure prevailing within the first volume 210, viscosity of the reaction mixture in the first volume 210 and/or previously determined signal in infrared spectrum of the reaction mixture in the first volume 210. For simplicity, the residence time of the reaction mixture is preferred. However, other process engineering parameters such as temperature, pressure and viscosity (as indicators of a progressing polymerization reaction) may also be used. In the case of polyurethane reaction mixtures monitoring of the NCO bands in the IR spectrum is also conceivable.

A further aspect of the present invention is a process for producing a foamed polymer. Individual steps shall be shown by way of example with reference to FIGS. 2, 3 and 4. The process comprises the steps of:
A) providing a system according to the invention;
B) positioning the seal 300 within the foaming mold 200 such that a first volume 210 having a first predetermined value of ≥0 m³ is formed;
C) positioning the limiter 310 at a distance from the seal 300, wherein the distance is chosen such that during contacting of the limiter 310 by the seal 300 the first volume 210 takes a second predetermined value which is greater than the first predetermined value;
D) introducing a reaction mixture comprising two reaction components mutually reactive to afford a polymer and a supercritical fluid into the first volume 210, wherein by the introducing of the reaction mixture, the seal 300 is initially moved toward the limiter 310 and then contacts said limiter so that the first volume 210 is limited to the second predetermined value and wherein the fluid remains in the supercritical state;
E) reacting the reaction mixture until a predetermined value of a parameter for the reaction mixture located in the first volume 210 is achieved;
F) repositioning the limiter 310 such that the first volume takes a third predetermined value which is different from the second predetermined value and wherein the fluid is in the subcritical state after this step.

According to step A) of the process a system according to the invention having a first mixer 140, foaming mold 200, seal 200, limiter 310, positioning unit 320, control unit 400 etc. is initially provided, so that the process may be performed with this system. An inventive system as shown in schematic form in FIG. 1 may be provided for example.

FIGS. 2, 3 and 4 show sections of an inventive system, wherein the focus is on showing the operations in the foaming mold 200. The situation after performing steps B) and C) of the process is shown in FIG. 2. The seal 300 is positioned within the foaming mold 200. A first volume 210 shown in FIG. 1 may be formed or the seal 300 lies flushly against the left hand edge of the foaming mold 200. Furthermore the limiter 310 is positioned within the foaming mold 200 such that when the seal 300 moves toward the limiter 310 and contacts said limiter a second predetermined value for the first volume 210 is taken.

FIG. 3 shows the situation after steps D) and E) of the process. From the conduit on the left hand side of the foaming mold 200 which as shown in FIG. 1 is connected to the first mixer 140 a reaction mixture is introduced into the foaming mold 200 and thus into the first volume 210. The reaction mixture comprises two mutually reactive components which form a polymer. Polyaddition polymers are preferred as the reaction products. The reaction mixture further comprises a supercritical fluid which serves as a blowing agent.

Examples of suitable blowing agent fluids are linear, branched or cyclic C₁- to C₆-alkanes, linear, branched or cyclic C₁- to C₆-fluoroalkanes N₂, O₂, argon and/or CO₂. The carbon dioxide may be formed during the reaction to afford a polyurethane foam, for example as a result of the reaction of isocyanates with water or with acids. Specific examples of hydrocarbon blowing agents are methane, ethane, propane, n-butane, isobutane, n-pentane, cyclopentane, n-hexane, isohexane, 2,3-dimethylhexane and/or cyclohexane. Further examples are the partially or perfluorinated derivatives of methane, ethane, propane, n-butane, isobutane, n-pentane, cyclopentane, n-hexane, isohexane, 2,3-dimethylbutane and/or cyclohexane.

The blowing agent fluid is in the supercritical state upon introduction into the first volume 210. It may be dissolved or emulsified in the reaction mixture. In emulsions the blowing agent may have a droplet size of ≥1 nm to ≤100 nm. The droplet size may also be ≥3 nm to ≤30 nm. Said size may be determined by dynamic light scattering or small angle neutron scattering and is to be understood as meaning an average of the droplet sizes.

The reaction mixture introduced into the foaming mold pushes the movable seal 300 toward the limiter 310 until said limiter is contacted and puts an end to further movement of the seal 300. The first volume 210 has then achieved its second predetermined value. Through choice of the conditions prevailing in the first volume 210 it is ensured that the fluid remains in the supercritical state.

According to step E) the reaction mixture is then reacted until a predetermined parameter generally correlated with the progress of the reaction in the reaction mixture is achieved. Supercritical conditions continue to prevail for the fluid. The first volume may still retain the second predetermined value from the preceding steps or else the size of the first volume may be varied in step E) provided that the fluid remains in the supercritical state.

After achieving the predetermined value of the parameter from step E) the fluid in the reaction mixture is in a subcritical state at the end of step F). This is achieved by repositioning the limiter such that the seal 300 is afforded further space to move and the first volume 210 can therefore enlarge. Once the subcritical state has been achieved, the third predetermined value may optionally be chosen such that the first volume 210 is reduced in size again. In this way cells in the foam material may be made to burst.

Upon transferral into the supercritical state, gaseous fluid is obtained, thus resulting in formation of a foam. The material may undergo further curing in the foaming mold 200 until a solid foam is obtained.

Consequently, the system according to the invention makes it possible to achieve a filling of the foaming mold in the first volume without complex control of a counterpressure cylinder, followed by a controlled expansion of the first volume.

In one embodiment of the process according to the invention, step A) comprises providing a system having at least the additional property that the foaming mold 200 further comprises a second volume 220 arranged on the side of the seal 300 opposite to the first volume 210 which is sealable with respect to the atmosphere and whose pressure is adjustable by means of a valve 330. Furthermore, at least until the end of step D) a pressure above the critical pressure of the fluid prevails in the second volume 220 and subsequently in step F) the pressure in the second volume 220 is reduced to a pressure below the critical pressure of the fluid.

This is likewise shown schematically in FIGS. 2 to 4. The second volume 220 may be used to build up counterpressure which ensures that during the expansion of the first volume the seal 300 moves relatively slowly, thus preventing inadvertent temporary subcritical conditions in the first volume. In the planned transferral of the reaction mixture into the subcritical state according to step F) the valve 330 may be opened.

In a further embodiment of the process according to the invention in step E) the parameter is selected from: residence time of the reaction mixture in the first volume 210, temperature of the reaction mixture in the first volume 210, pressure prevailing within the first volume 210, viscosity of the reaction mixture in the first volume 210 and/or previously determined signal in infrared spectrum of the reaction mixture in the first volume 210. For simplicity the residence time of the reaction mixture is preferred, for example ≥1 second to ≤60 seconds. However, other process engineering parameters such as temperature, pressure and viscosity (as indicators of a progressing polymerization reaction) may also be used. In the case of polyurethane reaction mixtures monitoring of the NCO bands in the IR spectrum is also conceivable.

In a further embodiment of the process according to the invention in step F) the repositioning of the limiter 310 is performed at a previously determined rate for the first volume 210. Based on the starting value for the first volume 210 immediately before the repositioning procedure, the rate may be for example ≥1% to ≤100% per second, preferably ≥10% to ≤80% per second, more preferably ≥20% to ≤60% per second. The rate may be constant (linear expansion) or variable over time so that for example a ramp is performed for the expansion.

In a further embodiment of the process according to the invention the fluid is carbon dioxide.

In a further embodiment of the process according to the invention the reaction mixture in step D) comprises an isocyanate component and a polyol component. Examples of suitable polyisocyanates for the isocyanate component are butylene 1,4-diisocyanate, pentane 1,5-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) or higher homologs (polymeric MDI, pMDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoates (lysine diisocyanates) having C₁ to C₆-alkyl groups. A mixture of MDI and pMDI is particularly preferred.

In addition to the abovementioned polyisocyanates, it is also possible to use proportions of modified diisocyanates of uretdione, isocyanurate, urethane, carbodiimide, uretoneimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

In the reaction mixture the ratio of the number of NCO groups in the isocyanate to the number of isocyanate-reactive groups may be from ≥70:100 to ≤500:100. This index may also be in the range from ≥180:100 to ≤330:100 or else from ≥90:100 to ≤140:100.

In the polyol component the polyol is preferably selected from the group comprising polyether polyols, polyester polyols, polycarbonate polyols, polyether ester polyols and/or polyacrylate polyols and wherein furthermore the OH number of the polyol is ≥100 mg KOH/g to ≤800 mg KOH/g, particularly preferably ≥350 mg KOH/g to ≤650 mg KOH/g, and the average OH functionality of the polyols is ≥2.

The polyols employable in accordance with the invention may have, for example, a number-average molecular weight Mₙ of ≥60 g/mol to ≤8000 g/mol, preferably of ≥90 g/mol to ≤5000 g/mol and more preferably of ≥92 g/mol to ≤1000 g/mol. In the case of a single added polyol the OH number indicates the OH number of said polyol. In the case of mixtures the average OH number is reported. This value may be determined in accordance with DIN 53240. The average OH functionality of the recited polyols is ≥2, for example in a range from ≥2 to ≤6, preferably from ≥2.1 to ≤4 and more preferably from ≥2.2 to ≤3.

Polyether polyols usable in accordance with the invention are, for example, polytetramethylene glycol polyethers, as obtainable by polymerization of tetrahydrofuran by means of cationic ring opening.

Likewise useful polyether polyols are addition products of styrene oxide, ethylene oxide, propylene oxide, butylene oxides and/or epichlorohydrin onto di- or polyfunctional starter molecules.

Examples of useful starter molecules include water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and low molecular weight hydroxyl-containing esters of such polyols with dicarboxylic acids.

In a further embodiment of the process according to the invention the polyol component comprises a first polyether polyol having a hydroxyl number (DIN 53240) of ≥400 mg KOH/g to ≤700 mg KOH/g and a second polyether polyol having a hydroxyl number (DIN 53240) of ≥700 mg KOH/g to ≤1000 mg KOH/g which is distinct from the first polyether polyol. Preference is given to trimethylolpropane-started EO-, PO- and/or EO/PO-polyether polyols.

In a further embodiment of the process according to the invention the polyol component further comprises a surfactant component from the group of: alkoxylated alkanols, alkoxylated alkylphenols, alkoxylated fatty acids, fatty acid esters, polyalkyleneamines, alkyl sulfates, alkyl polyethers, alkyl polyglucosides, phosphatidyl inositols, fluorinated surfactants, polysiloxane-comprising surfactants and/or bis(2-ethyl-1-hexyl) sulfosuccinate.

Alkoxylated alkanols employable according to the invention as the surfactant component are for example ethers of linear or branched alkanols having ≥10 to ≤30 carbon atoms with polyalkylene glycols having ≥2 to ≤100 alkylene oxide units. They may be for example ethers of linear alcohols having ≥15 to ≤20 carbon atoms with polyalkylene glycols having ≥5 to ≤30 ethylene oxide units.

Fluorinated surfactants may be perfluorinated or partially fluorinated. Examples thereof are partially fluorinated ethoxylated alkanols or carboxylic acids such as perfluorooctanoic acid.

A polysiloxane-comprising surfactant may for example be a siloxane-terminated polyalkylene oxide polyether. These surfactants may have a linear or branched structure. Such a surfactant employable according to the invention is obtainable for example by hydrosilylation of an unsaturated compound with a polysiloxane bearing Si—H groups. The unsaturated compound may be inter alia the reaction product of allyl alcohol with ethylene oxide or propylene oxide.

For example the surfactant may also be obtained by the reaction of polyether alcohols with a polysiloxane bearing Si—Cl groups. In the polyether all end groups maybe siloxane-terminated. It is also possible for mixed end groups to be present i.e. for siloxane end groups and OH end groups or OH end groups functionalized by reaction, such as methoxy groups, to be present. The siloxane terminus may be a monosiloxane group R₃Si—O— or an oligo- or polysiloxane group R₃Si—O[R₂Si—O]ₙ-[A)] where for example n is from ≥1 to ≤100. In the case of branched surfactants the siloxane terminus may also have a structure conforming to R₃Si—O—RSi[AO]—O—[R₂Si—O]ₘ—O—SiR₃ where for example m is from ≥0 to ≤10 or may have a comb polymer structure conforming to R₃Si—O—[RSi[AO]]ₙ—O—[R₂Si—O]ₘ—O—SiR₃ where m+n is from ≥0 to ≤250. It is preferable when in the recited cases the radical R is an alkyl group, in particular a methyl group. The group [AO] represents a polyalkylene oxide radical, preferably polyethylene oxide and/or polypropylene oxide. The group [AO] may also be bonded to the siloxane via a connecting group such as for example C₃H₆.

The process according to the invention allows controlled pressure reduction in the foam production.

This allows (reproducible) adjustment of cell size, cell structure, porosity, apparent density, compressive strengths, dimensional stability, surface structure and or further qualities of the foams.

In particular, foams having a particularly fine-celled structure are producible.

Also producible in particular, are foams in which the distribution of the apparent density is particularly homogeneous.

In a further particular embodiment, foams having a particularly high compressive strength are producible.

Foams having a particularly fine-celled structure coupled with particular compressive strength are producible using a particularly preferred embodiment of the process according to the invention.

A further advantage of the process is the high reproducibility of the obtained foam qualities.

1. A system for producing a foamed polymer, comprising:
a first mixer for mixing at least two mutually reactive reaction components to obtain a reaction mixture that reacts to afford a polymer, wherein at least one of the reaction components further comprises a supercritical fluid; and
a foaming mold for receiving the reaction mixture which is connected to the first mixer and has a first volume available for receiving the reaction mixture, wherein the first volume is variable;
wherein the foaming mold comprises a movable seal which delimits the first volume on at least one side and effects sealing at least against the outflow of liquid components;
wherein the system comprises a movable limiter which
is arranged on the side of the seal opposite the first volume,
is not connected or not securely connected to the seal,
which has a position that is positionable with a positioning unit wherein the positioning unit is adapted for performing instructions from a control unit, and
which is positionable in such a way as to block or allow according to the instructions from the control unit a movement of the seal which corresponds to an enlargement of the first volume; and
wherein the control unit is adapted for relaying instructions to the positioning unit according to at least one parameter of a reaction mixture located in the first volume.

2. The system as claimed in claim 1, wherein the foaming mold further comprises a second volume arranged on the side of the seal opposite to the first volume which is sealable with respect to the atmosphere and whose pressure is adjustable by means of a valve.

3. The system as claimed in claim 1, wherein the seal is implemented as a floating seal.

4. The system as claimed in claim 1, wherein the limiter is implemented as a mechanically, hydraulically or pneumatically propelled piston.

5. The system as claimed in claim 1, further comprising a pressure sensor, temperature sensor and/or viscometer which can relay the parameter(s) to the control unit.

6. The system as claimed in claim 1, further comprising a reservoir vessel fora first reaction component, a reservoir vessel for a second reaction component and a reservoir vessel for a fluid transferable into a supercritical state, wherein the reservoir vessel for the second reaction component and the reservoir vessel for the fluid transferable into a supercritical state are connected to a second mixer and an outlet of the second mixer and also the reservoir vessel for the first reaction component are connected to the first mixer.

7. The system as claimed in claim 6, wherein the reservoir vessel for the first reaction component is a reservoir vessel for an isocyanate component, the reservoir vessel for the second reaction component is a reservoir vessel for a polyol component and the reservoir vessel for the fluid transferable into a supercritical state is a reservoir vessel for carbon dioxide.

8. A process for producing a foamed polymer, comprising the steps of:
A) providing a system as claimed in claim 1;
B) positioning the seal within the foaming mold such that a first volume having a first predetermined value of ≥0 m³ is formed;
C) positioning the limiter at a distance from the seal, wherein the distance is chosen such that during contacting of the limiter by the seal the first volume takes a second predetermined value which is greater than the first predetermined value;
D) introducing a reaction mixture comprising two reaction components mutually reactive to afford a polymer and a supercritical fluid into the first volume, wherein, by the introducing of the reaction mixture, the seal is initially moved toward the limiter and then contacts the limiter so that the first volume is limited to the second predetermined value and wherein the fluid remains in the supercritical state;
E) reacting the reaction mixture until a predetermined value of a parameter for the reaction mixture located in the first volume is achieved;
F) repositioning the limiter such that the first volume takes a third predetermined value which is different from the second predetermined value and wherein the fluid is in the subcritical state after this step.

9. The process as claimed in claim 8, wherein:
in step A) the foaming mold further comprises a second volume arranged on the side of the seal opposite to the first volume which is sealable with respect to the atmosphere and whose pressure is adjustable by means of a valve,
at least until the end of step D) a pressure above the critical pressure of the fluid prevails in the second volume and
subsequently in step F) the pressure in the second volume is reduced to a pressure below the critical pressure of the fluid.

10. The process as claimed in claim 8, wherein in step E) the parameter is selected from at least one of: residence time of the reaction mixture in the first volume, temperature of the reaction mixture in the first volume, pressure prevailing within the first volume, viscosity of the reaction mixture in the first volume and and/or previously determined signal in the infrared spectrum of the reaction mixture in the first volume.

11. The process as claimed in claim 8, wherein in step F) the repositioning of the limiter is performed at a previously determined rate for the first volume.

12. The process as claimed in claim 8, wherein the fluid is carbon dioxide.

13. The process as claimed in claim 8, wherein the reaction mixture in step D) comprises an isocyanate component and a polyol component.

14. The process as claimed in claim 13, wherein the polyol component comprises a first polyether polyol having a hydroxyl number of ≥400 mg KOH/g to ≤700 mg KOH/g and a second polyether polyol having a hydroxyl number of ≥700 mg KOH/g to ≤1000 mg KOH/g which is distinct from the first polyether polyol.

15. The process as claimed in claim 13, wherein the polyol component further comprises at least one surfactant component from the group of: alkoxylated alkanols, alkoxylated alkylphenols, alkoxylated fatty acids, fatty acid esters, polyalkyleneamines, alkyl sulfates, alkyl polyethers, alkyl polyglucosides, phosphatidyl inositols, fluorinated surfactants, polysiloxane-comprising surfactants and bis(2-ethyl-1-hexyl) sulfosuccinate.
